(19) United States
(12) Patent Application Publication
(10) Pub. No.: US 2002/0145345 A1
(43) Pub. Date: Oct. 10, 2002

(54) Portable rocking device

(76) Inventor: Darrin Costa, Mineola, NY (US)

Correspondence Address: Darrin Costa, 285 Roselle Street, Mineola, NY, 11501, US

(21) Appl. No.: 09/827,702

(22) Filed: Apr. 6, 2001

(51) Int. Cl. H02K 7/10

(52) U.S. Cl. 310/75 R; 310/80

(57) ABSTRACT

The present invention is a portable device for rocking objects such as baby carriages and strollers. The device comprises a base, a motor, a gear, a sliding member and a fastening means. The gear is attached to the shaft of the motor and the sliding member is attached to the gear. Attached to the sliding member is a fastening means for fastening the present invention to the device to be rocked, When the present invention is activated the rotational motion of the motor is converted into a linear motion with an adjustable length and speed. When attached to an object such as a baby stroller, the present invention rocks the object back and forth.

The present invention is a portable device for rocking objects such as baby strollers and baby carriages.

### BACKGROUND OF THE INVENTION

Infants and children are often comforted by a slight motion and/or rocking feeling. As most parents or care-takers are aware, rocking a child in a stroller, or carriage, helps the child become relaxed and fall asleep. When a child requires continuous rocking for any extended period of time, this rocking motion becomes tiresome and burdensome for individuals. Additionally, when multiple children need to be rocked to sleep simultaneously, unless the parents or care-takers have help, it is nearly impossible to do so.

Although children swings and bouncers provide a rocking motion to comfort a child, for most children, these devices do not provide the most comfortable sleeping positions. A more natural sleeping position, and very often a child's most comfortable place, is in their carriage, stroller or rocker. There is no item that presently exists that allows for a child to be rocked within their carriage or stroller, while at the same time providing the care-taker who typically has the obligation of creating the rocking motion, the freedom to move about without these obligations.

The present invention is a portable rocking device that attaches to strollers or the like, which provides a continuous rocking motion and alleviates the care-taker of this responsibility. The care-taker who typically has the obligation to create the rocking motion, has freedom to tend to other children or tasks, instead of being confined to the rocking task for any lengthy period of time necessary to put a child to sleep or at ease and maintain that status.

### SUMMARY OF THE INVENTION

The present invention is a portable rocking device for rocking baby strollers and carriages. The portable rocking device of the present invention comprises a motor, a gear and a sliding arm, mounted on a portable base. The base can be made from any suitable material including but not limited to metal, plastic and wood. The motor is attached to the base by any suitable fastening means such as welding, bolting, screwing, or other fastening methods.

The motor of the portable rocking device can be reciprocating or centrifugal. In a preferred embodiment, a gear and sliding member are attached to a reciprocating motor to convert the motor's rotational motion into a linear motion. The sliding member can be made of any material which is strong enough to keep from bending or buckling. Plastic, metal, wood or combinations of these materials are examples of suitable materials. When operated, the motor rotates the gear, which engages teeth located on the sliding member. The motor spins in one direction thereby pushing the sliding member away from the motor until an adjustable set point is reached. Upon reaching this set point, the motor is reversed and spins in the opposite direction thereby pulling sliding member back towards the motor. The result is an adjustable length linear motion.

At the end of the sliding member furthest away from the motor of the portable rocking device, is a means for fastening the end of the sliding member to the baby stroller or carriage, or the like. A preferred means for fastening the sliding member to the carriage or stroller is a clamp. The clamp fastens to the sliding member at one end and fastens to the carriage or stroller at more than one location to provide stability. Preferably, the fastening means clamps to the lowest structural member perpendicular to the desired path of travel of the baby stroller or carriage such that it can be pushed and pulled. The result is the baby stroller or carriage rolls back and forth an adjustable distance. In another embodiment, the frequency of the rocking can be adjusted by including a speed adjustment on the motor, as known in the art.

Alternatively, the device can include a centrifugal motor that operates in only one direction without reversing while still creating the desired linear travel for the sliding member.

The present invention may be designed as a portable device. This provides the same advantages to the care-taker and child, both in the home and outside the home. Because this invention has the ability to be operated by battery pack, it may also be used outdoors or where there is no outlet readily available.

### DESCRIPTION OF THE DRAWINGS

FIG. 1 is a plan view of a preferred embodiment of the present invention without the enclosure.

FIG. 2 is a front view section of FIG. 1 taken along line A-A showing the enclosure.

FIG. 3 is a side view section of FIG. 1 taken along line B-B showing the enclosure.

FIG. 4 is a side view of the fastening means that incorporates a sliding member in another embodiment of the invention.

FIG. 5 is a front view of another embodiment of the present invention with an extension member, vibration isolators and height adjustors.

FIG. 6 is a front view of another embodiment of the present invention with a cam attached to the shaft of the motor.

FIG. 7 is a front view of another embodiment of the present invention with wheels attached to one end of the base and a non-slip material attached to the other end.

### DETAILED DESCRIPTION OF THE INVENTION

The present invention is a portable device for rocking objects such as baby carriages, baby strollers, or the like. In one embodiment of the invention, the portable rocking device comprises a base, a motor, a gear and a sliding member. The sliding member has a fastening means at the end furthest away from the motor so that it can be attached to a device such as a carnage, stroller or the like.

The base is a structural element such as a metal, wood, or plastic plate, board, mesh, or a combination of materials. The base provides structural support for the portable rocking device, provides locations for attachment of other elements of the invention, and provides weight to retard the opposing force produced by the pushing/pulling motion of the device. Alternatively, the base can be fixed by magnetic forces to a fixed ferro-magnetic surface, by suction cups to a smooth surface, by a nonskid material to a flat surface or any other method known in the art to temporarily fix and support in position.

The invention can also include one or more wheels attached at one end of the base to provide a means for transporting the device. Alternatively, the device could have wheels at more than one end with a means for preventing the device from moving during use. Such means includes brakes or other devices such as stop levers or rubber pads.

Attached to the base of the present invention is a motor to provide motion. The motor can be electrically and/or battery powered. The power source can be normal electricity from a household or office outlet, it could be from batteries or it could be by both at the option of the user. The motor can be attached to the base by any suitable method including bolting, welding, strapping, or the like. Many types of motors can be used in the device of the present invention including centrifugal, reciprocating, or the like. Such devices are common and known to those of ordinary skill in the art.

Attached to the shaft of the motor is a means for converting the rotational motion into a linear motion. A cam, tooth gear, or the like can be used to accomplish this. The cam, tooth gear, or the like can be made from metal, plastic, wood, or the like. Since the preferred range of travel distance provided by the device can be as much as a couple of feet, a significant size cam or multiple cams may be necessary if a cam is used in conjunction with a centrifugal motor. Alternatively, a relatively small disk or tooth gear can be used with a reciprocating motor. Other methods of converting the rotational motion of a motor to a linear motor are known to those in the art and can be implemented in the present invention.

A means for fastening the device of the present invention to the object to be rocked can be directly attached to the cam or tooth gear. The fastening means includes one or more clamps, hooks, clips, ties, magnets, spring loaded clamps, bolts and nuts, or the like. When used in conjunction with a tooth gear, the fastening means must also include some sort of straight portion with teeth to engage the teeth of the gear.

Alternatively, the fastening means can be connected to one end of a sliding member and the other end of the sliding member connects to the cam or gear or the like.

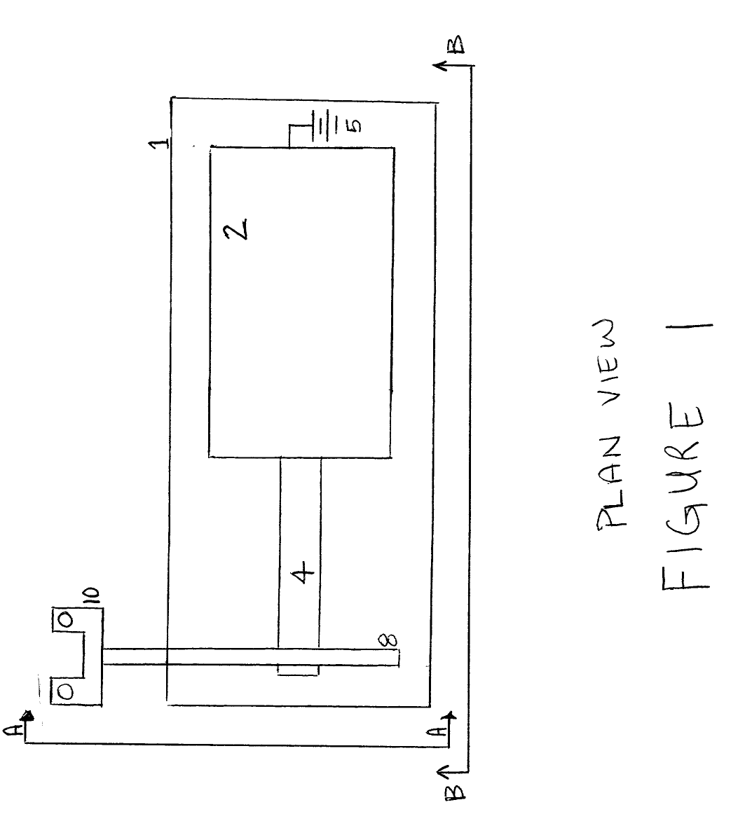

FIGS. 1, 2 and 3 show different views of one embodiment of the invention wherein, a reciprocating motor 2 is attached to a base 1. The motor has a power supply 5 and a shaft 4. A tooth gear 6 is attached to the shaft 4. When the motor 2 is turned on, the shaft 4 and the gear 6 rotate in a first direction. The teeth of the gear 6 engage the teeth of the sliding member 8 thereby pushing or pulling the fastening means 10 on the sliding member away or toward the motor. When the motor 2, tooth gear 6 or sliding member 8 reaches a first adjustable set point, a limit switch reverses the direction of the motor 2. Consequently, the sliding arm and fastening means 10 travel in a second direction which is opposite the first direction. A second limit switch is activated at a second point which returns the spin of the motor 2 to the original direction. The result is a linear motion with an adjustable length or stroke. In one embodiment of the invention, the frequency of the motion is controlled by having an adjustable speed on the motor 2. In an alternative embodiment of the invention, changing the size of the tooth gear 6 adjusts the frequency. When the device is attached to a rollable or rockable device such as a baby carriage or stroller, and the device is activated, the carriage or stroller rolls forward and back for the desired distance and frequency.

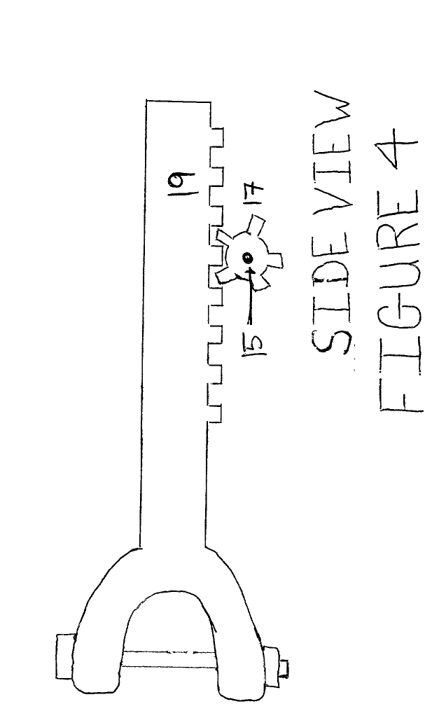

The fastening means 10 can be a separate device from the sliding arm 8 as shown in FIGS. 1, 2 and 3. Alternatively, it can be fabricated as part of the sliding member 8 thereby eliminating a distinguishable element from the device, namely the sliding member 8. Such an embodiment is shown in FIG. 4 wherein the fastening means 19 is attached directly to the gear 17 which is attached to the motor shaft 15. In either case, the fastening means 10 secures the device of the present invention to the apparatus to be rocked.

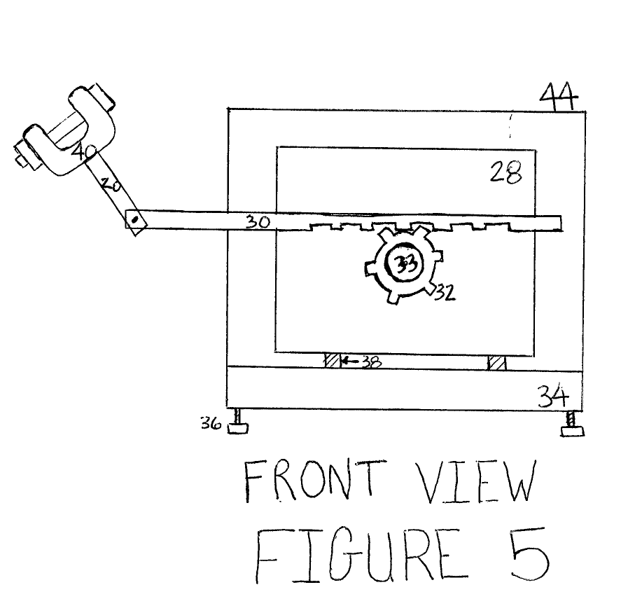

As shown in the embodiment in FIG. 5, an extension member 20 between the sliding member 30 and the fastening means 40 provides a greater distance between the object of the present invention and the object to be rocked. If the connection between the extension member 20 and the sliding member 30 is hinged as in FIG. 5, then the present invention can be attached at multiple heights on the object to be rocked.

Alternate methods of height adjustment for the invention, as depicted in the embodiment in FIG. 5 are adjustment knobs, screws, levers or the like 36 beneath the base 34 of the device. Alternatively, the same height adjustment devices can be located between the base 34 and the motor 28. FIG. 5 also shows an embodiment which incorporates vibration isolators 38 between the motor 28 and the base 34. The vibration isolators 38 can be made any material that inhibits resonance of vibration such as rubber. The embodiment depicted in FIG. 5 incorporates a tooth gear 32 on the shaft 33 of the motor 28.

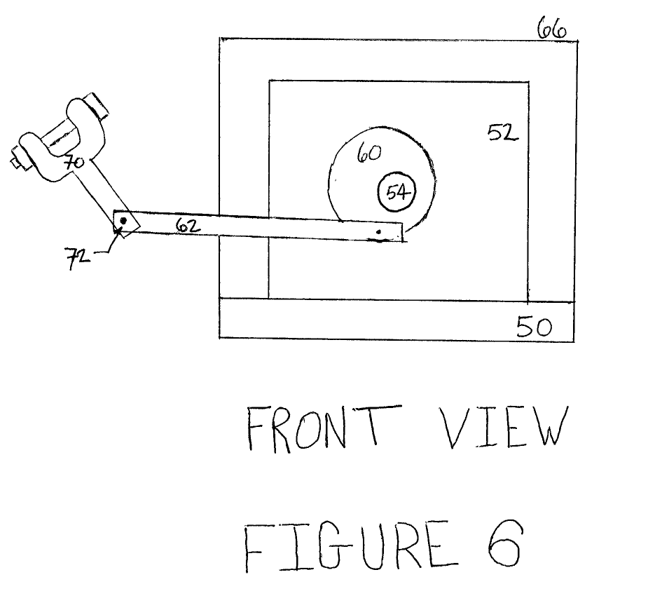

In yet another embodiment of the present invention shown in FIG. 6, a centrifugal motor 52 is attached to a base 50. A cam 60 is attached to the shaft 54 of the motor 52. A sliding member 62 without teeth is used. In this embodiment, the cam 60 is attached to the end of the motor's shaft 54 and the sliding arm 62 is attached to the cam 60.

The motor 52 is a centrifugal type motor and it does not need to reverse direction to complete both parts (i.e., both the pushing and pulling) of the desired travel. As shown in FIG. 6, the fastening means 70 can also be connected to the sliding member via a pivoting connection 72 to account for the height variance caused by the sliding member 62 rotating with the cam 60.

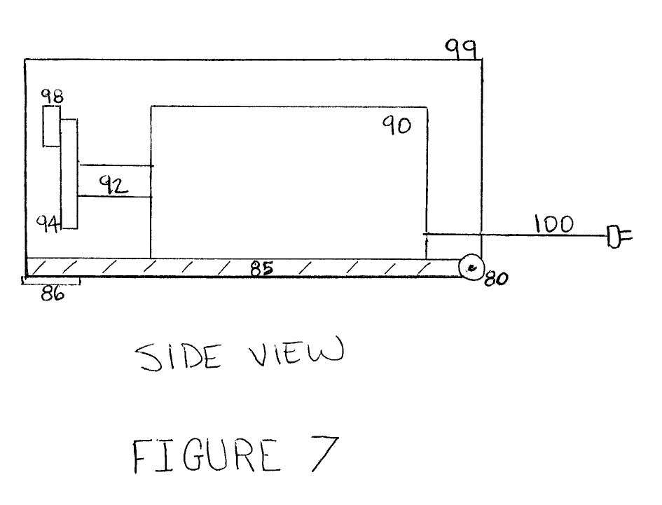

As shown in the embodiment in FIG. 7, a wheel 80 or a plurality of wheels can be attached to the base 85 of the device to provide ease in its transportation. When the wheels are attached to one end of the base 85, a non-slip material 86 such as rubber can be used at the other end of the base to stop the invention from slipping during operation. When a plurality of wheels are used and attached at both ends of the base 85, other methods can be used to keep the invention in a set location. Such methods include brakes for the wheels, a jack or jacks to lift the wheels off the ground, magnets or other mechanical securing devices for fastening the invention to a metal pole, fence or wall. These other methods can also be used on other embodiments of the invention that do not include a plurality of wheels. The motor 90 in FIG. 7 has a cam 94 attached to the shaft 92 of the motor. The sliding member 98 is attached to the cam 94. The fastening means is not depicted in this figure and the power supply can be provided to the motor from an outlet via power chord 100.

The invention can also be used to connect to a higher point on a baby stroller or carriage by placing the apparatus on a chair, table, or the like such that fastening means aligns with another part of connection on the device to be rocked. For example, the fastening mechanism can be secured to the handle or other structural member of the stroller or carriage.

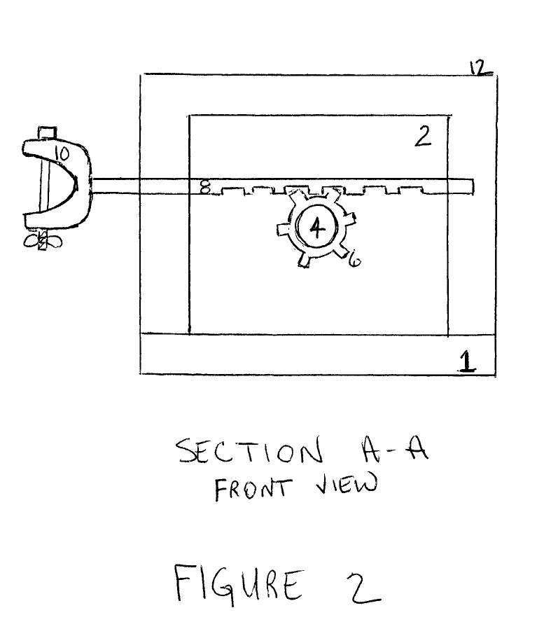

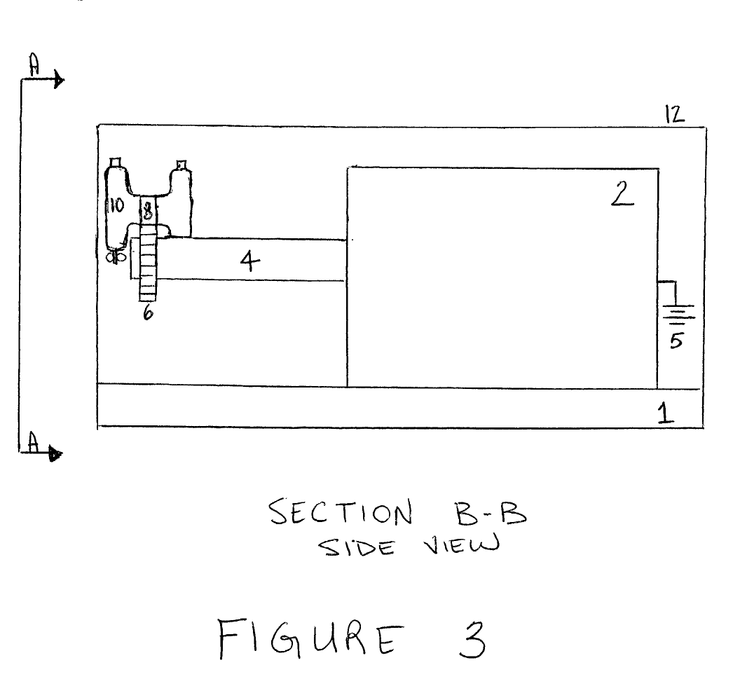

Further, embodiments of the invention can also include an enclosure for the entire device as shown in FIGS. 2 and 3 as enclosure 12 or in FIGS. 5, 6 and 7 as enclosure 44, enclosure 66, and enclosure 99, respectively.

The present invention is not limited to use with baby strollers or carriages. The present invention can also be used to rock wheelchairs, rocking chairs, or other rollable devices to which the device can be fastened.

The present invention can also be manufactured as part of a baby carriage or stroller. The invention can be made so that it can be removed from underside of the baby carriage or stroller and then attached to part of the device. Alternatively, the invention can be permanently secured to the underside of the carriage or stroller with a method of securing the invention to the floor so that when the invention is activated, the carriage or stroller rocks back and forth. Methods of securing the invention to the floor include brakes, level arms, jacks or the like. When the securing means is engaged and the invention is activated, the carriage or stroller rocks back and forth.

I claim:

1. A portable rocking device for rocking a baby carriage or stroller comprising:
a base;
a motor fastened to said base, said motor having a power supply and a rotating shaft;
a gear fastened to the shaft of said motor;
a sliding member having a first end engaged with said gear and a second end; and
a fastening means attached to the second end of said sliding member, said fastening means a method for securing said sliding member to objects such as baby carriages or strollers.

2. The portable rocking device set forth in claim 1, wherein the fastening means is selected from the group of devices including clamps, hooks, clips, magnets, screws, bolts and nuts, and ties.

3. The portable rocking device set forth in claim 1, wherein the motor is powered by an external electric power supply.

4. The portable rocking device set forth in claim 1, wherein the motor is powered by an internal power supply.

5. The portable rocking device set forth in claim 1, wherein the motor is powered by an internal or external power supply.

6. The portable rocking apparatus set forth in claim 1, wherein the speed of rotation of said motor is adjustable.

7. The portable rocking apparatus set forth in claim 1, wherein the length of the stroke of the invention is adjustable.

8. The portable rocking device set forth in claim 1, wherein the height of the base is adjustable.

9. The portable rocking apparatus set forth in claim 1, wherein said base has a first end and a second end with wheels connected to said first end and a non-sliding material at said second end.

10. The portable rocking apparatus set forth in claim 1, wherein said base has a plurality of wheels attached to it.

11. A portable rocking device for rocking a baby carriage or stroller comprising:
a base;
a motor fastened to said base, said motor having a power supply and a rotating shaft;
a gear fastened to the shaft of said motor;
a sliding member having a first end engaged with said gear and a second end;
an extension member having a first end and a second end, said first end of said extension member attached to the second end of said sliding member;
a fastening means attached to the second end of said extension member, said fastening means a method for securing said extension member to objects such as baby carriages or strollers.

12. The portable rocking device set forth in claim 11, wherein the fastening means is selected from the group of devices including clamps, hooks, clips, magnets, screws, bolts and nuts, and ties.

13. The portable rocking device set forth in claim 11, wherein the motor is powered by an external electric power supply.

14. The portable rocking device set forth in claim 11, wherein the motor is powered by an internal power supply.

15. The portable rocking device set forth in claim 11, wherein the motor is powered by an internal or external power supply.

16. The portable rocking apparatus set forth in claim 11, wherein the speed of rotation of said motor is adjustable.

17. The portable rocking apparatus set forth in claim 11, wherein the length of the stroke of the invention is adjustable.

18. The portable rocking device set forth in claim 11, wherein the height of the base is adjustable.

19. The portable rocking apparatus set forth in claim 11, wherein said base has a first end and a second end with wheels connected to said first end and a non-sliding material at said second end.

20. The portable rocking apparatus set forth in claim 11, wherein said base has a plurality of wheels attached to it.

21. A portable rocking device for rocking a baby carriage or stroller comprising:
a base;
a motor fastened to said base, the motor having a power supply and a rotating shaft;
a cam attached to the shaft of said motor;
a sliding member having a first end and a second end, said first end attached to said cam; and
a fastening means at the second end of said sliding member, said fastening means a method for securing said sliding member to objects such as baby carriages or strollers.

22. The portable rocking device set forth in claim 21, wherein the fastening means is selected from the group of devices including clamps, hooks, clips, magnets, screws, bolts and nuts, and ties.

23. The portable rocking device set forth in claim 21, wherein the motor is powered by an external electric power supply.

24. The portable rocking device set forth in claim 21, wherein the motor is powered by an internal power supply.

25. The portable rocking device set forth in claim 21, wherein the motor is powered by an internal or external power supply.

26. The portable rocking device set forth in claim 21, wherein the height of the base is adjustable.

27. The portable rocking apparatus set forth in claim 21, wherein the speed of rotation of said motor is adjustable.

28. The portable rocking apparatus set forth in claim 21, wherein the length of the stroke of the invention is adjustable.

29. The portable rocking apparatus set forth in claim 21, wherein said base has a first end and a second end with wheels connected to said first end and a non-sliding material at said second end.

30. The portable rocking apparatus set forth in claim 21, wherein said base has a plurality of wheels attached to it.

31. A portable rocking device for rocking a baby carriage or stroller comprising:
a base;
a motor fastened to said base, said motor having a power supply and a rotating shaft;
a cam attached to the shaft of said motor;
a sliding member having a first end and a second end, said first end attached to said cam; and
an extension member having a first end and a second end, said first end of said extension member attached to the second end of said sliding member;
a fastening means attached to the second end of said extension member, said fastening means a method for securing said extension member to objects such as baby carriages or strollers.

32. The portable rocking device set forth in claim 31, wherein the fastening means is selected from the group of devices including clamps, hooks, clips, magnets, screws, bolts and nuts, and ties.

33. The portable rocking device set forth in claim 31, wherein the motor is powered by an external electric power supply.

34. The portable rocking device set forth in claim 31, wherein the motor is powered by an internal power supply.

35. The portable rocking device set forth in claim 31, wherein the motor is powered by an internal or external power supply.

36. The portable rocking apparatus set forth in claim 31, wherein the speed of rotation of said motor is adjustable.

37. The portable rocking apparatus set forth in claim 31, wherein the length of the stroke of the invention is adjustable.

38. The portable rocking device set forth in claim 31, wherein the height of the base is adjustable.

39. The portable rocking apparatus set forth in claim 31, wherein said base has a first end and a second end with wheels connected to said first end and a non-sliding material at said second end.

40. The portable rocking apparatus set forth in claim 31, wherein said base has a plurality of wheels attached to it.

41. A method of rocking a baby carriage or stroller comprising the steps of:
providing an apparatus with a motor having a power supply and a rotating shaft, said apparatus having a gear fastened to the shaft of said motor and a sliding member attached to said gear at the first end of said sliding member, the second end of said sliding member having a fastening means attached to it;
attaching the fastening means of the apparatus to a part of the carriage or stroller; and
activating the apparatus.
